(19) United States
(12) Patent Application Publication
(10) Pub. No.: US 2008/0320062 A1
(43) Pub. Date: Dec. 25, 2008

(54) METHOD OF TRANSFERRING FILE SYSTEM, FILE SYSTEM TRANSFERENCE PROGRAM, AND FILE SYSTEM TRANSFERENCE DEVICE

(75) Inventors: Takeshi MIYAMAE, Kawasaki (JP); Yoshitake SHINKAI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/202,769

(22) Filed: Sep. 2, 2008

Related U.S. Application Data
(63) Continuation of application No. PCT/JP2006/303989, filed on Mar. 2, 2006.

(51) Int. Cl. G06F 12/02

(52) U.S. Cl. 707/205; 707/E17.01; 711/E12.002

(57) ABSTRACT

It is an object of the present invention to realize the transference of a file system without moving data. A transference source file system outputs to a device driver a physical block number included in extent information. A transference driver intercepts an I/O request to the device driver, and obtains a physical block number of the I/O destination. A transference tool obtains a physical block number from the transference driver, and outputs the physical block number to the transference destination file system in order to realize the transference of a file system.

### CROSS REFERENCE TO RELATED APPLICATION

This application is a continuation of PCT application of PCT/JP2006/303989, which was filed on Mar. 2, 2006.

### BACKGROUND OF THE INVENTION

1. Field of the Invention

The present invention relates to a method of transferring a file system to another file system, a transference program therefor, and a device for performing the transference of a file system.

2. Description of the Related Art

When a file system is to be transferred, file data has to be read from a transference source file system by using a widely accepted interface provided by an operating system, and the read file data has to be written to a storage device consisting of a disk device or the like by a transference destination because media formats for storing data in storage devices are different among file systems.

However, if the above described operations of reading a file from a disk device and writing the read file to another disk device are to be performed on all the files, an immense amount of time is required for the transference, which is problematic.

Patent Document 1 discloses a configuration in which first file management information and second file management information are provided to allow each file system to access one and the same data by using their own file management information so that different file systems can access common data.

Patent Document 2 discloses a configuration in which extent information, for specifying a storage position of a file on a disk device, created by the file system of one computer and extent information created by a file system of another computer are switched so that it is possible to access a file created by the file system of said another computer.

The invention of Patent Document 1 creates the file management information to be used for files in different file systems when the medium layout of the disk device of a particular file system is known, and when the medium layout is not known, the file management information cannot be created.

In the invention of Patent Document 2, a file is shared by different file systems, and thus it does not aim for the transference of file systems.

### Patent Document 1:

### Japanese Patent No. 2827495

### Patent Document 2:

### Japanese Patent Application Publication No. 2001-84168

### SUMMARY OF THE INVENTION

It is an object of the present invention to realize the transference of a file system without requiring the files to be moved.

The method of transferring a file system according to the present invention comprises:

causing, on the basis of an I/O request, a transference source file system to output storage position information specifying a storage position of a file on a storage device;

obtaining the storage position information output from the transference source file system; and

outputting the obtained storage position information to a transference destination file system in order to transfer a file system.

According to this invention, it is possible to transfer a file system even when the media layout of the transference source file system is not known.

In the method of transferring a file system according to the present invention:

when the storage position information of the file cannot be obtained from the transference source file system in midcourse of the transference of a file system, the transference destination file system writes to the storage device the file whose storage position information could not be obtained, and continues a file system transference operation by obtaining storage position information specifying a writing position of the file.

By employing this configuration, it is possible to continue file system transference operations by writing data of a file of the transference file system even when storage position information of the file cannot be obtained from the transference source file system in midcourse of the transference of a file system.

In the method of transferring a file system according to the present invention:

control is performed so that an empty area in a volume of a transference target is not released to the transference destination file when a file system is being transferred, and control is performed so that the volume of the transference target is added to the transference destination file system when the transference of the file system is completed.

By employing this configuration, it is possible to prevent data from being written to an empty area in the transference target volume when, for example, the transference destination file system writes, to a storage device, data and storage position information of a file in midcourse of the transference of a file system. Thereby, data stored in a volume of the transference target can be protected.

The method of transferring a file system according to the present invention comprises:

storing, as hard link information, information about a file or a directory having a plurality of link destinations when searching for a path for the transference source file system; and

constructing a file or a directory having a plurality of link destinations in a transference destination file system on the basis of the hard link information.

By employing this configuration, it is possible to reconstruct hard links in the transference destination file system even when the transference source file system has hard links.

The method of transferring a file system according to the present invention comprises:

specifying, as a transference starting directory, an arbitrary directory of a directory tree consisting of file management information of a transference source file system, and transferring to the transference destination file system only a directory that is under the specified transference starting directory.

By employing this configuration, it is possible to select files in the transference source file system and to transfer them to the transference destination file system. Thereby, after the transference is completed, the areas for files that were not transferred can be used as free areas.

The method of transferring a file system according to the present invention comprises:

storing in a storage area a path of a directory whose transference is completed, and restarting transference of a file system from a directory next to the directory stored in the storage area whose transference is completed at a time when a transference operation is interrupted if a transference operation is interrupted and then restarted.

By employing this configuration, the recovery time required for restarting the transference of a file system after interruption is reduced.

In the method of transferring a file system according to the present invention, the transference is performed without updating a volume when a file system is being transferred.

By employing this configuration, it is not necessary to back up data in order to cope with a failure of the transference.

The method of transferring a file system according to the present invention comprises:

causing, on the basis of an I/O request, a transference source file system to output as the storage position information a physical block number specifying a storage position of the file;

obtaining the physical block number output from the transference source file system; and

outputting the obtained physical block number and a file name to the transference destination file system in order to transfer a file system.

By employing this configuration, it is possible to transfer a file system by obtaining a physical block number specifying a storage position of a file from the transference source file system.

The method of transferring a file system according to the present invention comprises:

causing, on the basis of an I/O request, the transference source file system to output a physical block number specifying a storage position of the file to a device driver;

a transference driver for intercepting the I/O request to the device driver in order to obtain the physical block number; and

a transference tool for outputting the physical block number and a file name obtained by the transference driver to the transference destination file system in order to transfer a file system.

By employing this configuration, it is possible to realize the transference of a file system without moving a file on a storage device by obtaining a physical block number of the file by using the transference driver and outputting the physical block number and the file name to the transference destination file system by using the transference tool.

The method of transferring a file system according to the present invention comprises:

specifying a first file offset, and causing the first file offset to store first file data read from the storage device at a first address in a buffer;

causing, on the basis of an I/O request, the transference source file system to output a physical block number specifying a storage position of second file data having a second file offset;

causing second file data read from the storage position specified by the physical block number to be stored at a second address in the buffer;

calculating the second file offset on the basis of the first file offset, the first address, and the second address;

creating extent information specifying a storage position of the second file data on the storage device on the basis of the calculated second file offset and the physical block number; and

outputting the created extent information to the transference destination file system in order to transfer a file system.

Thereby, when files in which file offsets are set are to be transferred, the file offset of each piece of file data is calculated, and extent information including the file offset and the physical block number is output to the transference destination file system so that the file system can be transferred.

### BRIEF DESCRIPTION OF THE DRAWINGS

FIG. 1 shows a transference source file system and a transference destination file system;

FIG. 2 shows a configuration of a module of a file system transference program according to an embodiment;

FIG. 3 shows a configuration of extent information;

FIG. 4 is a flowchart of an extent extraction process;

FIG. 5 is a flowchart of a process of calculating a file offset;

FIG. 6 shows a buffer address;

FIG. 7 is a flowchart of a hard link process;

FIG. 8 shows a directory tree; and

FIG. 9 shows a configuration of hard link information.

### DESCRIPTION OF THE PREFERRED EMBODIMENTS

Hereinafter, a method of transferring a file system according to embodiments of the present invention will be explained by referring to the drawings.

In this embodiment of the present invention, a case is explained in which a transference source file system stores extent information specifying a storage position at which a file is stored in a disk device, and a transference tool (to be explained later) extracts that extent information and gives it to a transference destination file system in order to realize the transference of a file system. The present invention is not limited to this, and it is not always necessary for the transference file system to have a function of creating the extension information. It is enough if the transference source file system can obtain information specifying the storage position of a file and give the information to the transference destination file system.

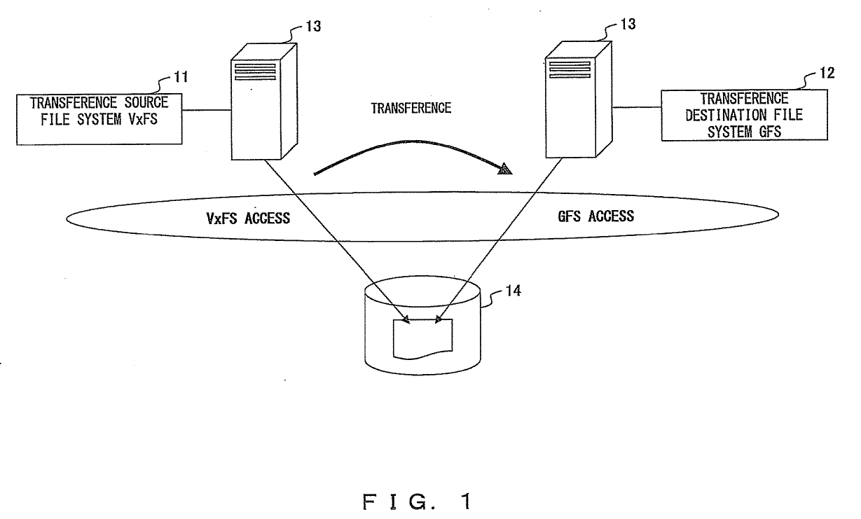

FIG. 1 shows a configuration of a file system according to an embodiment that includes a transference source file system 11 and a transference destination file system 12.

The transference source file system (as an example, the name of this file system is VxFS) 11 and the transference destination file system (as an example, the name of this file system is GFS) 12 are included in one and the same computer 13. The files managed by the transference source file system 11 are stored in an external storage device 14. Also, the transference destination file system 12 supports multi volumes and has a function to add data volumes of the transference source file system 11 after transference.

A method of transferring a file system according to an embodiment realizes the transference of a file system even when the transference destination file system 12 does not have information on what format is used by the transference source file system 11 for storing files in the external storage device 14, said transference being realized by obtaining from the transference source file system 11 a physical block number (which corresponds to the storage position information) specifying a storage position of a file and by outputting that physical block number and the file name to the transference destination file system 12.

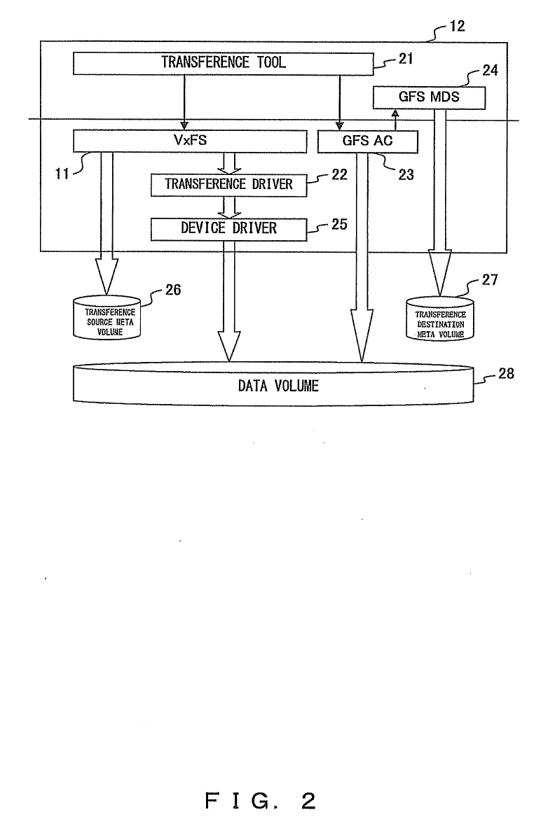

FIG. 2 shows a configuration of a program module for realizing the method of transferring a file system according to an embodiment.

A computer 13 includes the transference source file system (VxFS) 11, a transference tool 21, a transference driver (Smart Share) 22, an access client (AC) 23 for the transference destination file system 12, a meta data server (MDS) 24 for the transference destination file system 12, a device driver 25, and the like.

The transference source file system 11 beforehand creates extent information for specifying a storage position of a file and stores it in a transference source meta volume 26.

When the transference tool 21 issues, to the transference source file system 11, a command to read all the files, the transference source file system 11 sequentially reads the extent information stored in the transference source meta volume 26, and outputs the physical block numbers included in the extent information to the device driver 25. The transfer driver 22 intercepts the I/O request to the device driver 25, obtains the physical block numbers of the I/O destination, and stores the physical block numbers in such a manner that they are associated with memory addresses of the buffer (to be explained later).

The transference tool 21 obtains from the transference driver 22 the memory addresses selected when the physical block numbers and the file data were stored in the buffer. Then, the transference tool 21 calculates a file offset from this information, and creates the extent information of the transference destination file system 12 from the calculated file offset and the physical block number, and outputs it to the access client 23. The meta data server 24 stores in a transference destination meta volume 27 the extent information received via the access client 23. The creation of this extent information is performed on all the files existing in a data volume 28, and thereby the transference of a file system is realized.

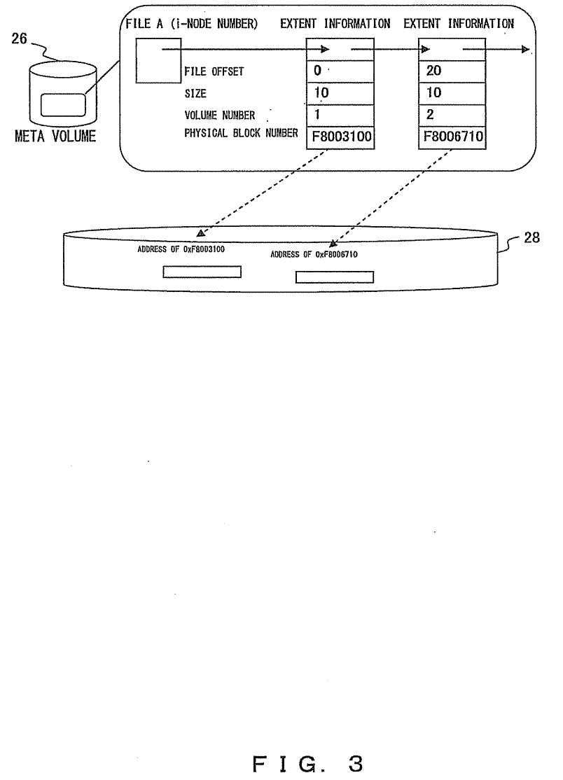

FIG. 3 shows a configuration of the extent information. The extent information includes, as shown in FIG. 3, a file offset, a size, a volume number, and a physical block number of file A identified by an i-node number. The volume number represents a number assigned to each volume when the data volume 28 is divided into a plurality of volumes, and the physical block number specifies a storage position in the data volume 28. One or a plurality of pieces of the extension information are created for one file, and are stored in the transference source meta volume 26 or the transference destination meta volume 27.

The extent information shown in FIG. 3 represents a configuration in which the file data of ten blocks of the file offset “0” is stored in the physical block number “F8003100” of the volume number “1” in the data volume 28. It also represents a configuration in which the file data of ten blocks of the file offset “20” is stored in the physical block number “F8006710” of the volume number “2” in the data volume 28.

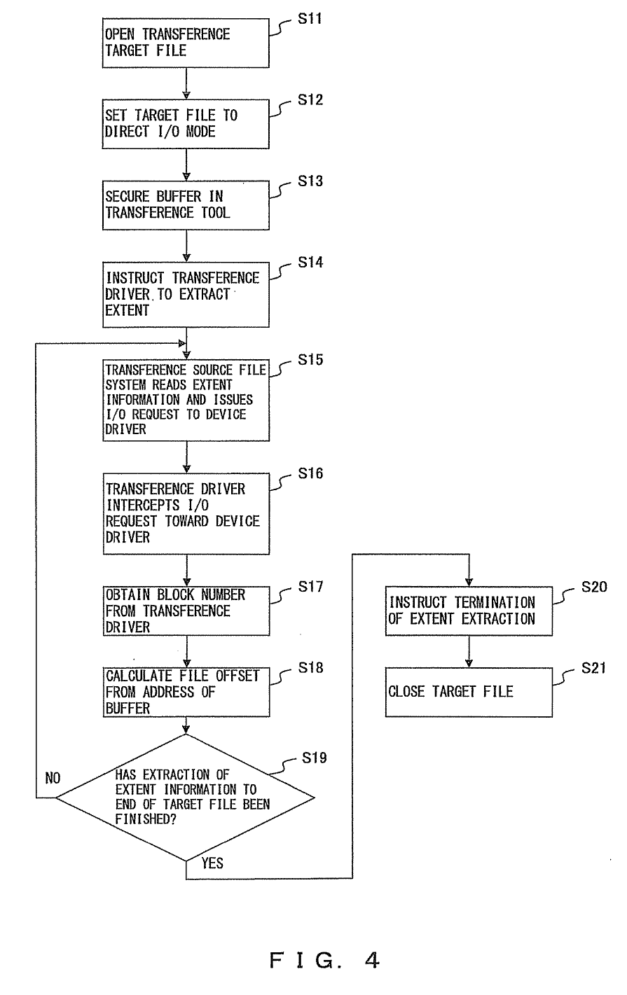

Next, an extent extraction process in which, when the extent information of a file is created beforehand by the transference source file system 11, the transference tool 21 obtains the physical block number specifying the storage position of the file in the data volume 28 and the block number is output to the transference destination file system 12 will be explained by referring to the flowchart shown in FIG. 4.

The transference source file system 11 opens (S11 in FIG. 4) a transference target file (hereinafter, referred to as a target file).

Next, the transference tool 21 is set to access the target file in the direct I/O mode (S12). By performing the setting of the direct I/O mode, the transference source file system 11 does not use a cache when reading the target file, and thus the transference source file system 11 always issues an I/O request when reading data.

Next, a buffer is secured (S13) to be used when the target file is stored in the memory area managed by the transference tool 21. When this step is executed, the memory address of the buffer is made to be, for example, a two-byte boundary and the buffer size is made to be, for example, an integer multiple of 512 bytes in order to access the target file in the direct I/O mode.

Next, the transference tool 21 specifies the memory address of the buffer and the buffer size, and instructs the transference driver 22 to extract the extent information (S14) For example, the SS_GETEXTST command of ioctl is issued.

When “read” in the direct I/O mode is instructed, the transference source file system 11 reads the extent information of the target file from the transference source meta volume 26, and issues an I/O request to the device driver 25 on the basis of the extent information. The file data read from the data volume 28 is stored at a prescribed memory address secured by the transference tool 21.

The transference driver 22 obtains the physical block number of the I/O destination by intercepting the I/O request of the device driver 25, and stores the physical block number in such a manner that that physical block number and the memory address of the buffer at which the file data was stored by the transference source file system 11 are associated with each other (S16) . Additionally, in order to apply the direct I/O, the file offset is set to be, for example, a value that is an integral multiple of 512 bytes so that the I/O scope does not exceed the file size.

Next, the transference tool 21 obtains the physical block number and the memory address of the buffer from the transference driver 22 (S17).

Next, the transference tool 21 calculates a file offset for each physical block number (S18). The transference tool 21 outputs, for example, the file name, the file offset, the volume number, the physical block number, and the like to the transference destination file system 12.

Next, by repeatedly using the above buffer, it is determined whether or not the extraction of the extent information from the file offset “0” to the file end of the target file is finished (S19). When the extraction of the extent information is not finished (No in S19), the process returns to step S15, and the above process is repeated.

When the extraction of the extent information to the file end of the target file is finished (Yes in S19), the process proceeds to step S20, and the transference tool 21 instructs the transference driver 22 to terminate the extraction of the extent information while specifying the memory address of the buffer. For example, it outputs the SS_GETEXTEND command of iocnt. Thereafter, the target file is closed (S21).

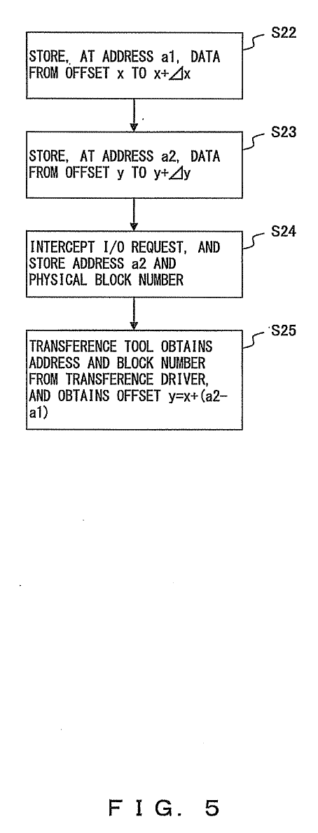

Next, a process of calculating the file offset of the steps S15 through S18 in FIG. 4 will be explained by referring to a flowchart in FIG. 5.

The transference tool 21 specifies the direct I/O mode, and causes the transference source file system 11 to read file data from an arbitrary file offset (for example, from file offset x) to a prescribed point (for example, to “X+Δx), and to store the read file data at memory address a1 in the buffer (S22 in FIG. 5). By this process, the file data in the area from the file offset x to x+Δx is stored at and after memory address al of the buffer.

The transference source file system 11 reads the extent information of the target file from the transference source meta volume 26, and reads file data of an arbitrary file offset after outputting the physical block number in the extent information to the device driver 25. Then, the read file data is stored at a prescribed address (for example, memory address a2) (S23).

The transference driver 22 intercepts the I/O request from the transference source file system 11 to the device driver 25, obtains the physical block numbers, and stores the physical block numbers in such a manner that they are associated with memory addresses of the buffer (S24).

The transference tool 21 calculates file offset y on the basis of the equation y=x+(a2−a1) from the memory address a1 (corresponding to the first address) at which the data of file offset x is stored and memory address a2 (corresponding to the second address) obtained from the device driver 25 (S25).

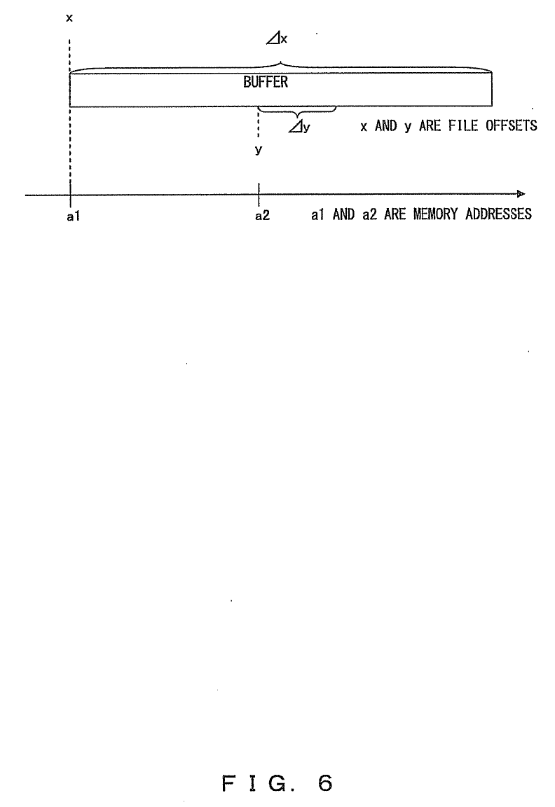

FIG. 6 shows a method of calculating a file offset. The data from the file offset x to “x+Δx” is stored at and after memory address al in the buffer.

Next, the data from an arbitrary file offset y to “y+Δy” is stored at and after memory address a2 in the buffer by the transference source file system 11. At the same time, when the data of the target file is stored, the transference tool 21 does not have information on file offset y of the target file.

The transference tool 21 has information of memory address al of the buffer at which the file data of file offset x is stored and can obtain from the transference driver 22 memory address a2 at which the file data of unknown offset y is stored. Accordingly, it can calculate file offset y from these pieces of information. Then, it is possible to create extent information of the file data in the transference destination file system 12 on the basis of the calculated file offset y and the physical block number obtained from the device driver 25.

By performing the extraction of the above extent information on all the files managed by the transference source file system 11, the transference of a file system is realized.

According to the extent extraction process of the above embodiment, even when the media layout of the transference source file system 11 is not known, information specifying the storage position of a file is output from the transference source file system 11 on the basis of the I/O request and the transference tool 21 and the transference driver 22 obtain the information and give it to the transference destination file system 12, and thereby a file system can be transferred without moving a file.

Also, because data of the data volume (transference source volume) is not added before the transference of the file system is completed, it is not necessary to back up data in order to cope with a failure of the transference. Also, the transference tool 21 and the transference driver 22 may be realized in the form of a single program module.

When the above extent extraction process is performed, the extent information of a file can sometimes not be extracted in the middle of the extraction. This happens because some file systems hold data of a file of a small size in an area for storing the i-node number of the transference source meta volume 26. Other examples of cases in which extent information cannot be extracted include a case in which data is left in cache, a case in which there is an area to which extent information is not assigned (area not having data in the data volume 28), a case in which the file end is a last block of a file that is out of a prescribed byte boundary (for example, 512 bytes), and the like. In these cases, a data block is not in the data volume 28, and accordingly extent information cannot be extracted and there is a probability that the transference of a file system will not be able to be continued.

In order to solve the above problem, in the present embodiment, when the transference source file system 11 has read the data of a file from the data volume 28, the transference tool 21 writes this data directly to the transference destination file system 12 on the basis of the write system call, utilizing the fact that the actual data is stored in the buffer. When receiving the write system call, the transference destination file system 12 writes the file data to the data volume that is managed by the transference destination file system 12 similarly to the usual write operation, and at the same time, creates extent information including the physical block number specifying the storage position of the file.

When the transference of a file system is in midcourse, the data volume 28 has a storage area in which the data is actually stored but the extent information is not set. If an area in which the extent information is not set in the data volume 28 of the target is considered to be an empty area when the transference tool 21 outputs the write system call and the transference destination file system 12 writes the data of the file for which the extent information could not be extracted, there is a probability that data will be written to that empty area (actually storing data).

In order to solve this problem, the present embodiment causes the operators to execute the addvol command (a command for the volume addition) of the nonactive mode when starting the transference of a file system so that an area in which extent information of the data volume 28 of the transference target exists is not considered to be an empty area by the transference destination file system 12. When the transference of a file system is completed, the operators are caused to execute the addvol command of the active mode so that the data volume 28 is added to the transference destination file system 12 and an empty area in the data volume 28 of the transference target is recognized. In other words, control is performed so that the data volume 28 of the transference target is not released to the transference destination file system 12 when the transference of a file system is in midcourse, and when the transference is completed, the data volume 28 is added to the transference destination file system 12.

When the transference of a file system is performed, it is necessary to construct in the transference destination file system 12 the configuration of the hard link of the transference source file system 11 without changing it. The hard link has a plurality of link destinations.

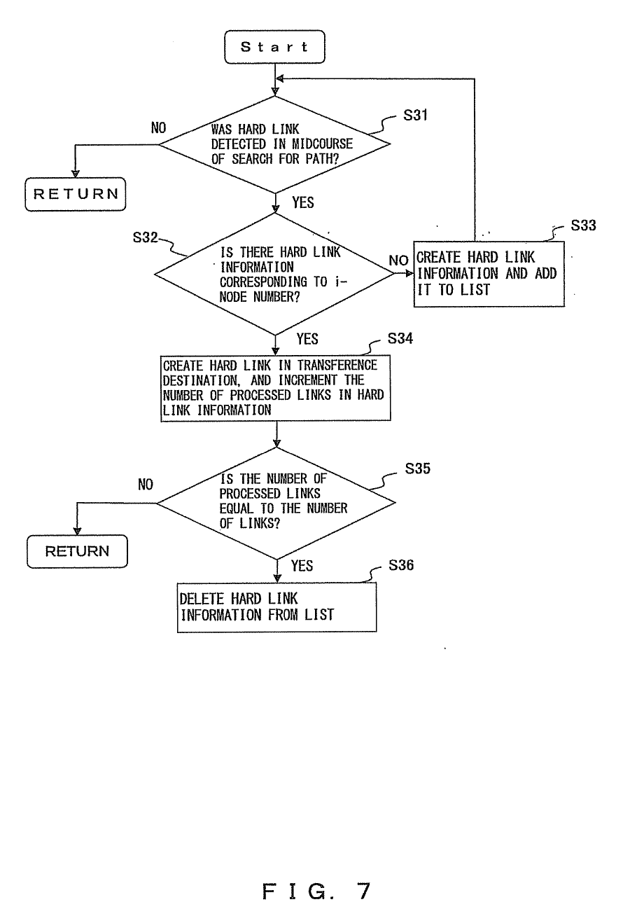

The hard link process for constructing in the transference destination the configuration of the hard link in the transference source according to the present embodiment will be explained by referring to the flowchart shown in FIG. 7.

The transference tool 21 determines whether or not a hard link is detected in midcourse of the search for the path of the transference source file system 11 (S31 in FIG. 7). The detection of a hard link is performed on the basis of whether or not the number of links of the file is equal to or greater than two.

When a hard link is not detected in step S31, the process returns to the previous process (the extent extraction process, for example).

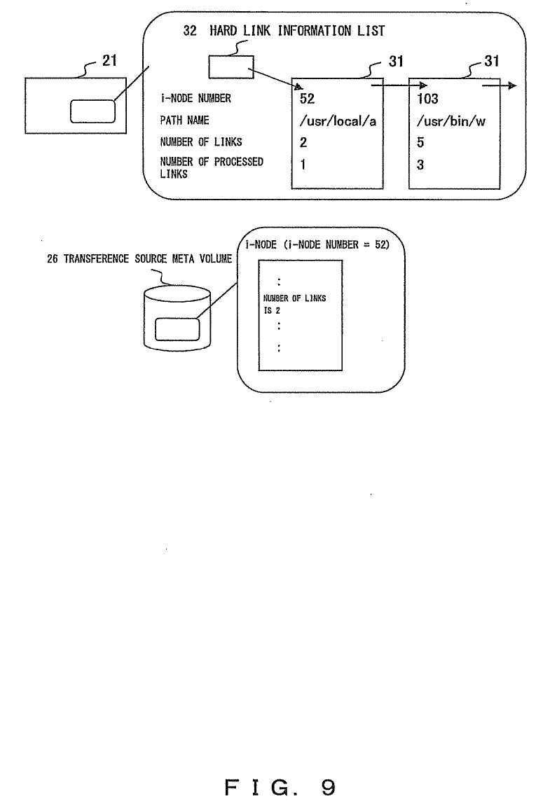

When a hard link is detected (Yes in S31), the process proceeds to step S32, and it is determined whether or not there is hard link information 31 (see FIG. 9) corresponding to the i-node number of the hard link file in a hard link information list 32 (see FIG. 9).

When there is no hard link information 31 in the hard link information list 32 (No in S32), the process proceeds to step S33, and a file is newly created, and thereafter the hard link information 31 in which the i-node number, the path name, the number of links, and the number of processed links are associated is created, and that hard link information 31 is added to the hard link information list 32.

When there is hard link information 31 corresponding to the i-node number in the hard link information list 32 (Yes in S32), the process proceeds to step S34, and a hard link corresponding to the hard link of the transference source directory is created in a directory in the transference destination, and the number of processed links of the hard link information 31 is incremented.

Next, it is determined whether or not the incremented number of processed links and the number of links of the hard link information 31 are equal to each other (S35).

When the number of processed links and the number of links are not equal to each other (No in S35), the process returns to the previous step.

When the number of processed links and the number of links of the hard link information 31 are equal to each other (Yes in S35), the process proceeds to step S36, and the corresponding hard link information is deleted from the hard link information list 32 and the area is released.

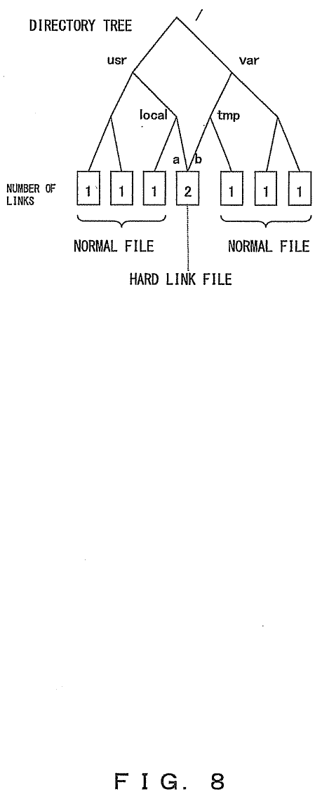

Next, the creation of a directory including a hard link will be explained by referring to the configuration view of the hard link information 31 shown in FIG. 9 and the directory tree shown in FIG. 8.

As shown in FIG. 8, when detecting, in a directory of the transference source file system 11, the hard link file “/user/local/a” that has two or more links, the transference tool 21 creates a file “/user/local/a” in the transference destination file system 12 by using the create system call, and at the same time, creates the hard link information 31 in which the i-node number, the path name, the number of links, and the number of processed links are associated.

FIG. 9 shows the configuration of the hard link information 31 and the hard link information list 32.

The hard link information 31 includes the i-node number for specifying a file, the path name, the number of links, and the number of processed links. When a hard link is detected, one piece of the hard link information 31 is created for the i-node number, and that hard link information 31 is registered in the hard link information list 32.

FIG. 9 shows the hard link information 31 in which the i-node number is “52”, the path name is “/usr/local/a”, the number of links is “2”, and the number of processed links is “1”. Also, it shows other hard link information 31 in which the i-node number is “103”, the path name is “/usr/bin/w”, the number of links is “5”, and the number of processed links is “3”.

When a hard link is detected in the above hard link process, the i-node number is specified and the hard link information 31 is created, and thereafter the created hard link information 31 is registered in the hard link information list 32.

A specific example of the hard link process will be explained by referring to the directory tree in FIG. 8 and the hard link information 31 in FIG. 9.

When, for example, a hard link /usr/local/a is detected when the path search is in midcourse and the hard link information 31 of the corresponding i-node number is not registered in the hard link information list 32, the number of links of the directory information, i.e. “2” is obtained, and the hard link information 31 as shown in FIG. 9 is created to be registered in the hard link information list 32.

When the path search is restarted and the hard link /var/tmp/b is detected, it is determined whether or not the hard link information 31 corresponding to the i-node number of that file b is registered in the hard link information list 32. When the hard link information of the same i-node number is registered in the hard link information list 32, the hard link /var/tmp/b corresponding to /usr/local/a is created in the directory tree of the transference destination file system 12. Then, the number of processed links in the hard link information 31 is incremented. When the number of processed links and the number of links are equal to each other, the hard link information 31 is deleted from the hard link information list 32.

According to the hard link process of the above embodiment, it is possible to construct, in the transference destination file system 12, the structure of the hard link of the transference source file system 11 without changing it by referring to the hard link information 31 corresponding to the hard link information list 32 when the hard link of the transference source file system 12 is detected.

Also, when a file system is to be transferred, an arbitrary directory can be specified as a transference starting directory instead of specifying the root directory of the transference source file system as the transference starting directory.

By employing the above configuration, it is possible to limit the scope of the transference target files to the files under a particular directory. Accordingly, when it is not necessary to transfer all the files managed by the transference source file system 11, only the files under a particular directory that are needed by the transference destination system can be transferred. Thereby, the time period required for the transference operation is reduced and all of the remaining areas can be used as unoccupied areas without deleting files after the transference.

Also, by storing the path names whose transference is completed in a secondary storage device such as a memory device, it is possible to restart the transference from the path that is not completed when the transference failed and has to be restarted. Thereby, the operation time period between when an error occurred in midcourse of the transference and the transference is restarted can be reduced.

The scope of the present invention is not limited to the above embodiments, and as examples, such configurations as below can be employed.

(1) The present invention can be applied not only to a file in which one file is separated into a plurality of pieces of file data by using file offsets in order to be stored in a disk device, but to a configuration in which one file block is stored in a disk device.
(2) The information specifying the storage position of a file to be output to the transference destination file system is not limited to the extent information explained in the embodiments, and any format can be used for the information.
(3) The transference source file system 11 and the transference destination file system 12 do not have to be included in one and the same computer, but can be included separate computers.
(4) The storage device for storing files is not limited to one disk device, and the present invention can be applied to a case in which files are distributed over a plurality of disk devices.

What is claimed is:

1. A method of transferring a file system, comprising:
causing, on the basis of an I/O request, a transference source file system to output storage position information specifying a storage position of a file on a storage device;
obtaining the storage position information output from the transference source file system; and
outputting the obtained storage position information to a transference destination file system in order to transfer a file system, wherein:
a first file offset is specified, and first file data read from the storage device is caused to be stored at a first address in a buffer;
the transference source file system is caused, on the basis of an I/O request, to output a physical block number specifying a storage position of second file data having a second file offset;
second file data read from the storage position specified by the physical block number is caused to be stored at a second address in the buffer;
the second file offset is calculated on the basis of the first file offset, the first address, and the second address;
extent information specifying a storage position of the second file data on the storage device is created on the basis of the calculated second file offset and the physical block number; and
the created extent information is output to the transference destination file system in order to transfer a file system.

2. The method of transferring a file system according to claim 1, wherein:
when the storage position information of the file cannot be obtained from the transference source file system in midcourse of a transference of a file system, the transference destination file system writes to the storage device the file whose storage position information could not be obtained, and continues a file system transference operation by obtaining storage position information specifying a writing position of the file.

3. The method of transferring a file system according to claim 2, wherein:
control is performed so that an empty area in a volume of a transference target is not released to the transference destination file when a file system is being transferred, and control is performed so that the volume of the transference target is added to the transference destination file system when the transference of the file system is completed.

4. The method of transferring a file system according to claim 1, comprising:
storing, as hard link information, information about a file or a directory having a plurality of link destinations when searching for a path for the transference source file system; and
constructing a file or a directory having a plurality of link destinations in a transference destination file system on the basis of the hard link information.

5. The method of transferring a file system according to claim 1, comprising:
specifying, as a transference starting directory, an arbitrary directory of a directory tree consisting of file management information of a transference source file system, and transferring to the transference destination file system only a directory under the specified transference starting directory.

6. The method of transferring a file system according to claim 1, comprising:
storing in a storage area a path of a directory whose transference is completed, and restarting transference of a file system from a directory next to the directory stored in the storage area whose transference is completed at a time when a transference operation is interrupted if a transference operation is interrupted and then restarted.

7. The method of transferring a file system according to claim 1, wherein:
transference is performed without updating a transference source volume when a file system is being transferred.

8. The method of transferring a file system according to claim 1, comprising:
causing, on the basis of an I/O request, a transference source file system to output as the storage position information a physical block number specifying a storage position of the file;
obtaining the physical block number output from the transference source file system; and
outputting the obtained physical block number and a file name to the transference destination file system in order to transfer a file system.

9. The method of transferring a file system according to claim 1, comprising:
causing, on the basis of an I/O request, the transference source file system to output a physical block number specifying a storage position of the file to a device driver;
a transference driver for intercepting the I/O request to the device driver in order to obtain the physical block number; and
a transference tool for outputting the physical block number and a file name obtained by the transference driver to the transference destination file system in order to transfer a file system.

10. A computer-readable storage medium storing a file system transference program for making a computer to execute a transference process of a file system, said process comprising:
a step of causing, on the basis of an I/O request, a transference source file system to output storage position information specifying a storage position of a file on a storage device;
a step of obtaining the storage position information output from the transference source file system;
a step of specifying a first file offset, and storing, first file data read from the storage device, at a first address in a buffer;
a step of causing the transference source file system, on the basis of an I/O request, to output a physical block number specifying a storage position of second file data having a second file offset;
a step of causing second file data read from the storage position specified by the physical block number to be stored at a second address in the buffer;
a step of calculating the second file offset on the basis of the first file offset, the first address, and the second address;
a step of creating extent information specifying a storage position of the second file data on the storage device on the basis of the calculated second file offset and the physical block number; and
a step of outputting the created extent information to the transference destination file system in order to transfer a file system.

11. The computer-readable storage medium according to claim 10, said process comprising:
a step in which, when the storage position information of the file cannot be obtained from the transference source file system in midcourse of a transference of a file system, the transference destination file system writes to the storage device the file whose storage position information could not be obtained; and
a step of continuing a file system transference operation by obtaining storage position information specifying a writing position of the file.

12. The computer-readable storage medium according to claim 10, said process comprising:
a step of storing, as hard link information, information about a file or a directory having a plurality of link destinations when searching for a path for the transference source file system; and
a step of constructing a file or a directory having a plurality of link destinations in a transference destination file system on the basis of the hard link information.

13. The computer-readable storage medium according to claim 10, comprising:
a transference driver for intercepting the I/O request output from the transference source file system to the device driver in order to obtain the physical block number specifying a storage position of the file; and
a transference tool for outputting the physical block number and a file name obtained by the transference driver to the transference destination file system in order to transfer a file system.

14. A file system transference device, comprising:
obtainment unit obtaining storage position information specifying a storage position of a file on a storage device output from a transference source file system on the basis of an I/O request; and
transference unit outputting the storage position information obtained by the obtainment unit to a transference destination file system in order to transfer a file system, wherein:
a first file offset is specified, and first file data read from the storage device is caused to be stored at a first address in a buffer;
the transference source file system is caused, on the basis of an I/O request, to output a physical block number specifying a storage position of second file data having a second file offset;
second file data read from the storage position specified by the physical block number is caused to be stored at a second address in the buffer;
the second file offset is calculated on the basis of the first file offset, the first address, and the second address;
extent information specifying a storage position of the second file data on the storage device is created on the basis of the calculated second file offset and the physical block number; and
the created extent information is output to the transference destination file system in order to transfer a file system.

15. A file system transference device according to claim 14, comprising:
continuation unit in which, when the storage position information of the file cannot be obtained from the transference source file system in midcourse of a transference of a file system, the transference destination file system writes to the storage device the file whose storage position information could not be obtained, and continues a file system transference operation by obtaining storage position information specifying a writing position of the file.
